(19) United States
(12) Patent Application Publication
(10) Pub. No.: US 2025/0109773 A1
(43) Pub. Date: Apr. 3, 2025

(54) FLOATING BRAKE ROTOR ASSEMBLY

(71) Applicant: HB PERFORMANCE SYSTEMS, INC., Mequon, WI (US)

(72) Inventor: Stephen R. Fiacchino, Port Washingon, WI (US)

(21) Appl. No.: 18/478,160

(22) Filed: Sep. 29, 2023

(51) Int. Cl. F16D 65/12; F16D 65/02

(52) U.S. Cl. CPC F16D 65/123; F16D 2065/1316; F16D 2065/1348; F16D 2065/1376; F16D 2065/1396

(57) ABSTRACT

A floating brake rotor assembly including a hub, a disc and a retainer. The hub includes a plurality of grooves. The disc has a center aperture where the hub is positioned. The disc has a plurality of tabs with each tab having therein a groove and each groove on each tab aligned with a groove hub. The retainer runs through each aligned groove on the hub and each groove on the disc to secure the disc to the hub and to enable the disc to move radially relative to an axle axis.

### FIELD OF THE INVENTION

The invention relates to a full floating or semi-floating brake rotor assembly, and more specifically, to full floating or semi-floating brake rotor assembly having a disc secured to a hub with a retainer to enable the disc to move radially relative to an axle axis and having a defined allowable axial displacement as full floating or no axial movement as semi-floating.

### BACKGROUND OF THE INVENTION

Full floating and semi-floating brake rotor assembly typically include a hub and disc that are coaxially arranged. The hub and the disc need to be secured together and are commonly secured together with retention components such as connecting pins, clips and threaded bolts. Such retention components add weight and cost to the assembly along with increasing the complexity and the number of parts. Such retention components also add thickness to the assembly in the axial direction that necessitates clearance in the brake design for functionality.

### SUMMARY OF THE INVENTION

In one construction, the disclosure a floating brake rotor assembly comprising a hub having an axle axis and a plurality of spokes, each spoke having therein a groove; a disc having a center aperture where the hub is positioned, the disc having a plurality of tabs around a periphery of the center aperture, each tab having therein a groove and each tab aligned with one spoke such that the groove on each tab is aligned with a groove on each spoke; and a retainer positioned in each aligned groove on the hub and each groove on the disc to secure the disc to the hub and to enable the disc to move radially relative to the axle axis.

In another construction, the disclosure provides a floating brake rotor assembly comprising a disc having a center aperture; a hub positioned in the center aperture and having an axle axis; a plurality of tabs on one of the disc and the hub and a plurality of pockets on the other of the disc and the hub, wherein one tab is positioned in each pocket; a raceway defined by a path through each of the plurality of tabs and each of the plurality of pockets; and at least one retainer running along the raceway to secure the disc to the hub and to enable the disc to move radially relative to the axle axis.

In another construction, the disclosure provides a floating brake rotor assembly comprising a disc having a center aperture and having a first surface plane and a second surface plane; a hub positioned in the center aperture and having an axle axis and retaining portions that engage with the disc; and a retainer securing the disc to the retaining portions of the hub to enable the disc to move radially relative to the axle axis such that the retainer and retaining portions are positioned between the first surface plane and the second surface plane.

Other aspects of the disclosure will become apparent by consideration of the detailed description and accompanying drawings.

### BRIEF DESCRIPTION OF THE DRAWINGS

FIG. 1 is a top view of a floating brake rotor assembly of the present invention.

FIG. 2 is an exploded perspective view of the floating brake rotor assembly.

FIG. 3 is a sectional view taken along line 3-3 of FIG. 1.

FIG. 4 is a top view of a disc.

FIG. 5 is a sectional view along line 5-5 of FIG. 4.

FIG. 6 is a perspective view of the disc.

FIG. 7 is a top view of a hub.

FIG. 8 is an end view of the hub.

FIG. 9 is a perspective view of the hub.

FIG. 10 is a top view of a retainer.

FIG. 11 is a perspective view of a second embodiment of a hub.

### DETAILED DESCRIPTION OF THE INVENTION

Before any constructions of the disclosure are explained in detail, it is to be understood that the disclosure is not limited in its application to the details of construction and the arrangement of components set forth in the following description or illustrated in the following drawings. The disclosure is capable of other constructions and of being practiced or of being carried out in various ways.

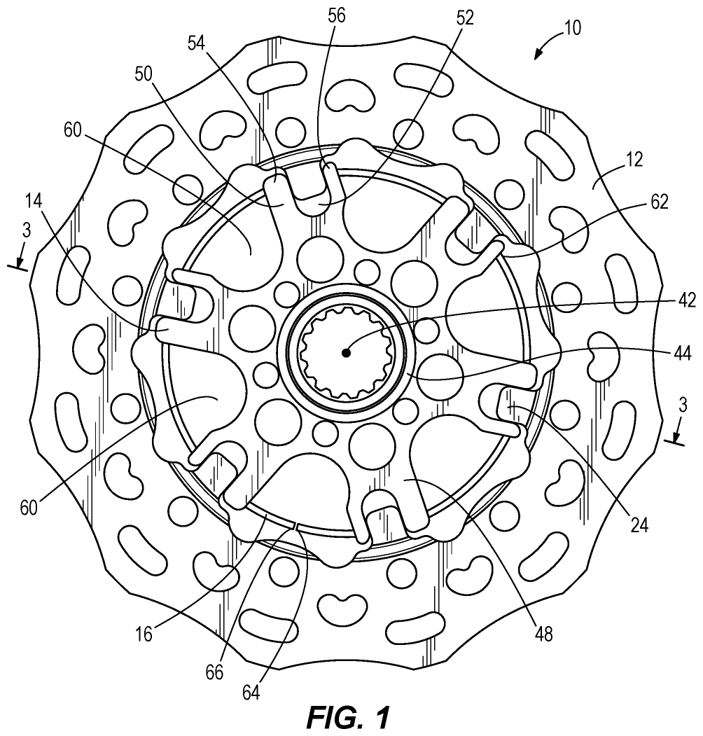

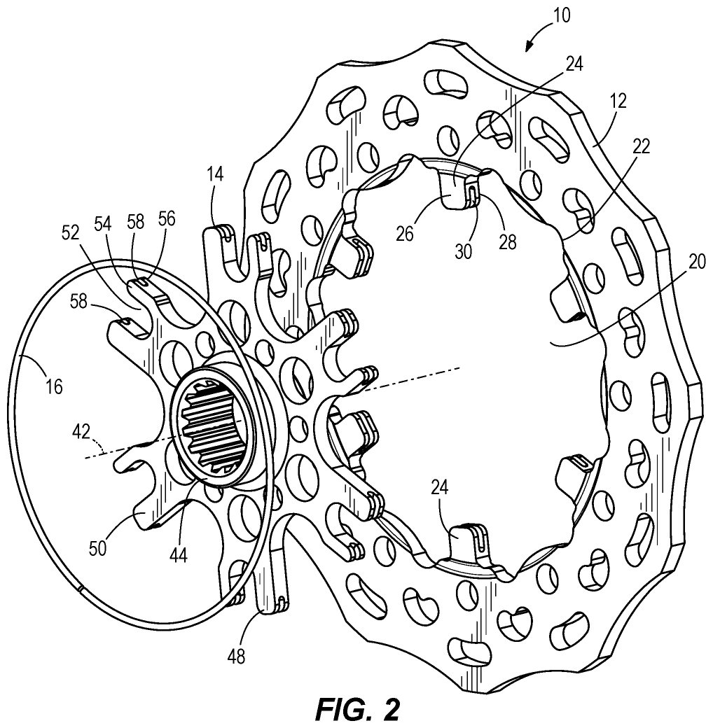

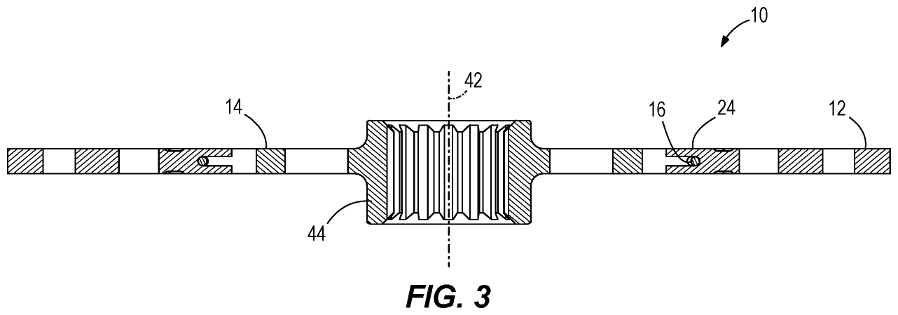

FIGS. 1-3 illustrate a floating brake rotor assembly 10. The assembly 10 includes a disc 12, a hub 14 and a retainer 16. The disc 12, the hub 14 and the retainer 16 are orientated relative to one another so that the disc 12 floats in a radial direction but does not float in an axial direction. The assembly 10 can be utilized with vehicles such as power sports equipment including ATVs, UTVs, snowmobiles and motorcycles for example. It should be noted that the invention is applicable to both full floating and semi-floating brake rotor assemblies.

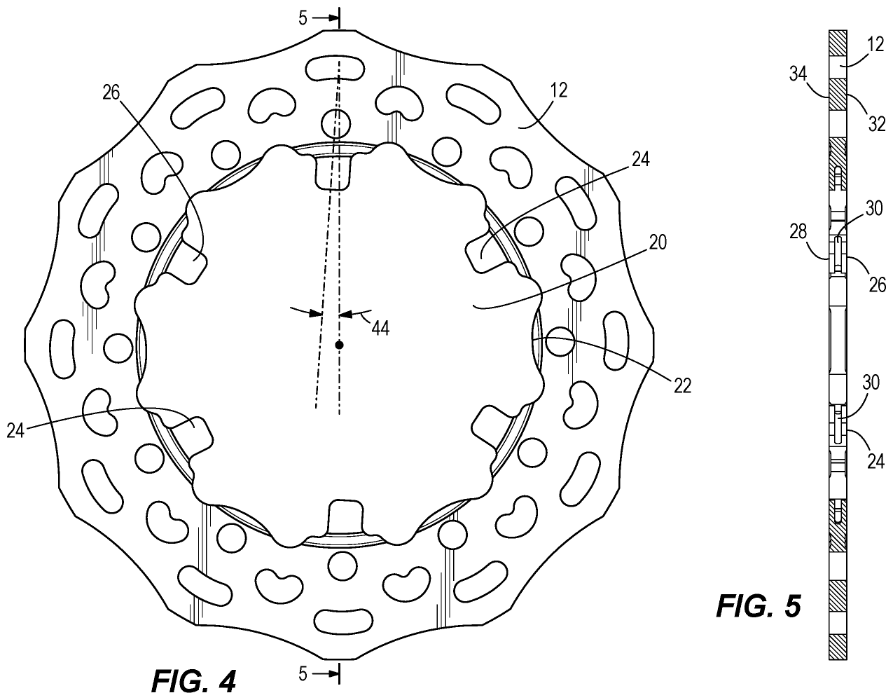

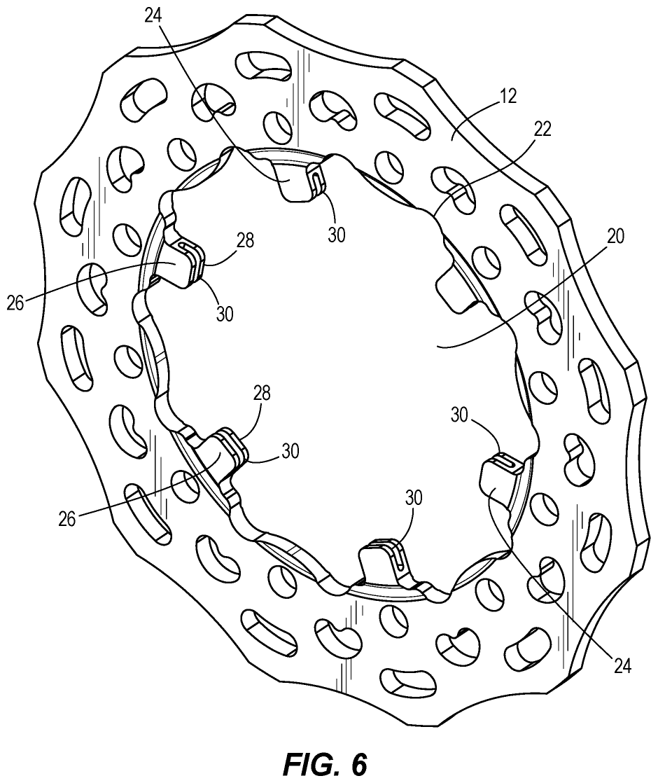

FIGS. 4-6 illustrate the disc 12. Preferably, the disc 12 is a ring of steel, stainless steel or a composite such as carbon ceramic, however, other shapes and materials can also be utilized. The disc 12 is preferably annular with a central aperture 20 and an inner periphery 22. A plurality of tabs 24 are spaced around the inner periphery 22. Each tab 24 includes two generally parallel projections 26 and 28 defining a groove 30 therebetween. As shown, the disc 12 includes six tabs 24, however, other numbers of tabs 24 can also be utilized such as at least three tabs. The disc 12 has a first surface plane 32 and a second surface plane 34. The tabs 24 are preferably centered between the two planes 32 and 34, however, other orientations can also be utilized. The tabs 24 are preferably not radially centered in that they are tilted by an angle A, however, they can also be oriented in a non-tilted position. The disc 12 interfaces with brake friction on its surface and the tabs transfer a brake torque load into the hub 14.

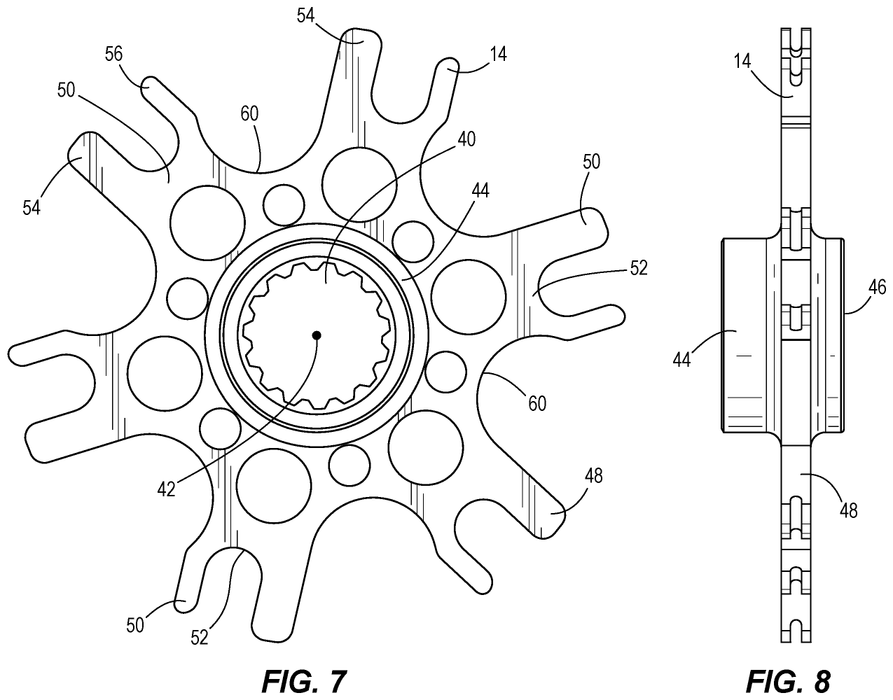

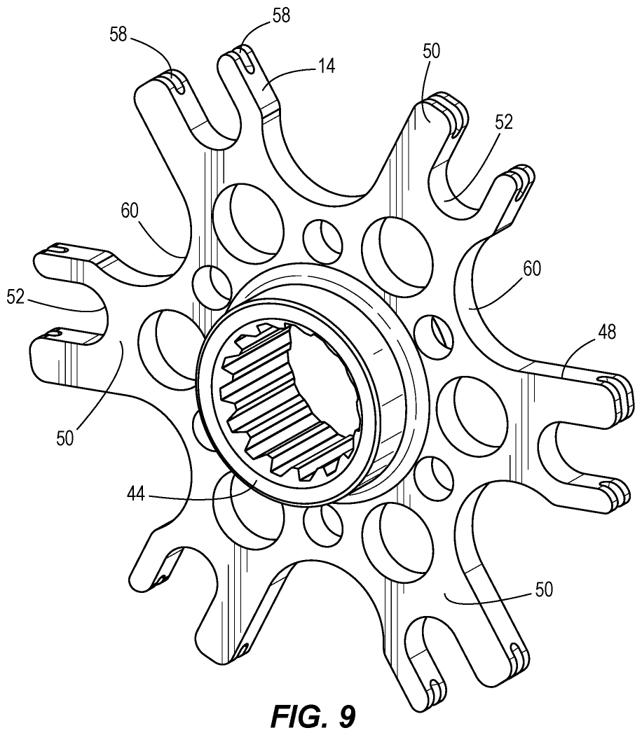

FIGS. 7-9 illustrate the hub 14. Preferably, the hub 14 is made from any metal, alloy or composite material such as aluminum, steel or stainless steel, however, other materials can also be utilized. The hub 14 has an axle aperture 40, an axle axis 42 and a pair of axially aligned collars 44 and 46. As shown, the collars 44 and 46 are of different sizes, however, the collars 44 and 46 can be the same size for universality of installation. The hub 14 includes a plurality of retaining portions 48 for engaging with the disc 12. In one embodiment, the retaining portions 48 include a plurality of spokes 50 extending radially from the axle aperture 40. Each spoke 50 includes a pocket 52 and a pair of arms 54 and 56 defining the pocket 52 therebetween. Each arm 54 and 56 includes a groove 58. The arms 54 and 56 are of different sizes, however, the same sized arms 54 and 56 can also be utilized. As shown, there are six spokes 50, however, other numbers of spokes 50 can also be utilized such as at least three spokes. Each pocket 52 is dimensioned to house one tab 24. Preferably, each tab 24 is positioned within a pocket 52 and preferably between the arms 54 and 56 of each spoke 50 with a minimum amount of clearance. The hub 14 interfaces with the disc 12 to transfer a brake torque load into the hub 14 through the tabs 24. The hub 14 transfers the torque load into a shaft or axle (not shown) mounted in the axle aperture 40. The hub 14 includes gaps 60 between adjacent spokes 50. The gaps 60 aid in assembly of the assembly 10.

When the hub 14 is positioned in the center aperture 20 of the disc 12 and the tabs 24 are housed in the pockets 52, an annual raceway 62 is defined through all of the grooves 30 of the tabs 24 and through all of the grooves 58 of the plurality of spokes 50. It should be noted that the tabs 24 could be positioned on the hub 14 and the pockets 52 on the disc 12 if desired for a particular application.

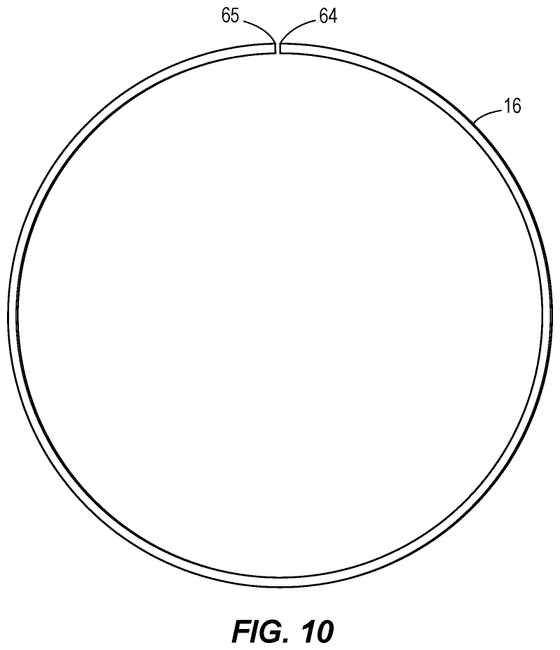

FIG. 10 illustrates the retainer 16. Preferably, the retainer 16 is a wire, cable or flat ring fabricated of steel, stainless steel or other material, however other types and quantities of retainers 16 can also be utilized such as multiple wires and springs.

In assembled form, the grooves 58 on the hub 14 and the grooves 30 on the disc 12 are aligned to form the raceway 62 that is annular, however, other shapes can also be utilized. The retainer 16 is housed in the raceway 62 to secure the disc 12 to the hub 14.

Turning back to FIGS. 1-3, to assemble the floating brake rotor assembly 10, the hub 14 is positioned in the center aperture 20 of the disc 12 such that one tab 24 on the disc 12 is positioned in one pocket 52 of the hub 14 to align the grooves 30 on each of the tabs 24 with the grooves 58 on each of the spokes 50 to form the raceway 62. The retainer 16 is fed through the raceway 62 to secure the disc 12 to the hub 14. The ends 64 and 66 of the retainer 16 can either abut one another as is shown or can be secured to one another such as by welding, by forging or by overlapping. The assembly 10 is then mounted on an axle (not shown) for use as is known in the art. If the collars 44 and 46 of the hub 14 are of the same size and the tabs 24 on the disc 12 are not tilted, the assembly 10 can be mounted universally on an axle.

In operation, the assembly 10 enables the disc 12 to be secured to the hub 14 while allowing the disc 12 to expand as needed radially or radially/axially so that torsional braking forces pass directly from the disc 12 to the hub 14. The disc 12 is secured to the hub 14 using the retainer 16 such that the torque load is passed directly between the disc 12 and hub 14 and not through any retention part securing the disc 12 to the hub 14.

The assembly 10 enables a floating disc functionality with only three parts, the disc 12, the hub 14 and the retainer 16. The weight of the assembly 10 is reduced as compared to the use of heavier retention components not being necessary for functionality.

The packing of the assembly 10 axially is significantly reduced by placing all of the components needed for functionality between the planes 32 and 34 of the disc 12. This aids significantly with clearance issues.

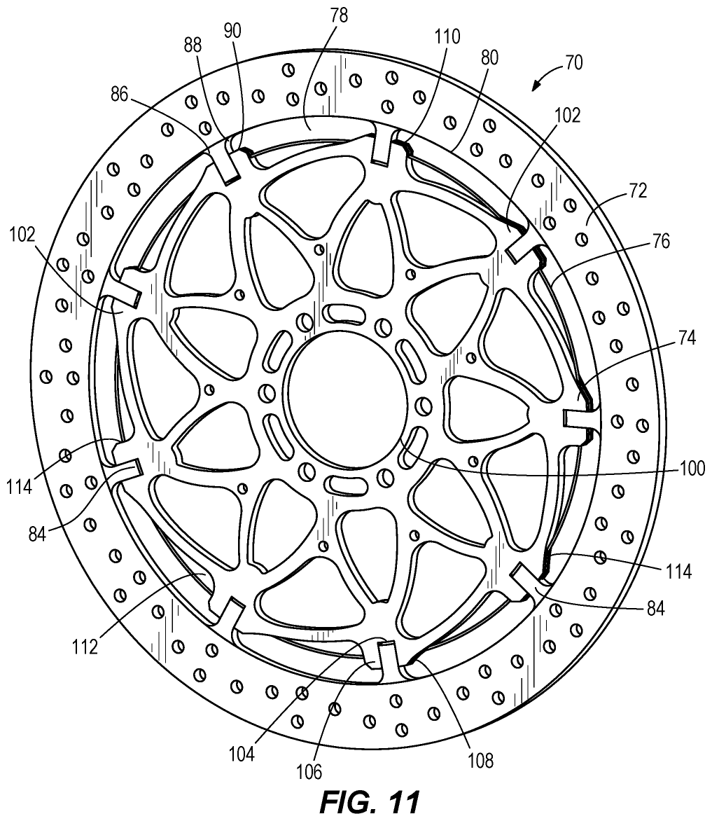

With reference to FIG. 11, a second embodiment of a floating brake rotor assembly 70 is shown. The assembly 70 includes a disc 72, a hub 74 and a retainer 76. The disc 72, the hub 74 and the retainer 76 are oriented relative to one another so that the disc 72 floats in a radial direction but does not float in an axial direction. The assembly 70 can be utilized with vehicles such as power sports equipment including ATVs, UTVs, snowmobiles and motorcycles for example.

The disc 72 is a ring of steel, stainless steel or a composite such as carbon ceramic, however, other shapes and materials can also be utilized. The disc 72 is preferably annular with a central aperture 78 and an inner periphery 80. A plurality of tabs 84 are spaced around the inner periphery 80. Each tab 84 includes two generally parallel projections 86 and 88 defining a groove 90 therebetween. As shown, the disc 72 includes nine tabs 84, however, other quantities can be utilized.

Preferably, the hub 74 is made from any metal, alloy or composite material such as aluminum, steel or stainless steel, however, other materials can be utilized. The hub 74 has an axle aperture 100. The hub 74 includes a plurality of retaining portions 102 for engaging with the disc 72. Each retaining portion 102 includes a pocket 104 and a pair of arms 106 and 108 defining the pocket 104 therebetween. Each arm 106 and 108 includes a groove 110. As shown, there are nine retaining portions 102, however, other quantities can be utilized. Each pocket 104 is dimensioned to house one tab 84. Preferably, each tab 84 is positioned within a pocket 104 and preferably between the arms 106 and 108 with a minimum amount of clearance. The hub 74 interfaces with the disc 72 to transfer a brake torque load into the hub 74 through the tabs 84. The hub 74 transfers the torque load into a shaft or axle (not shown) mounted in the axle aperture 100. The hub 74 includes gaps 112 between retaining portions 102 to aid in the assembly of the assembly 70.

When the hub 74 is positioned in the center aperture 80 of the disc 72 and the tabs 84 are housed in the pockets 104, an annual raceway 114 is defined through all of the grooves 90 of the tabs 84 and through all of the grooves 110 of the retaining portions 102. It should be noted that the tabs 84 could be positioned on the hub 74 and the pockets 104 on the disc 72 if desired for a particular application.

Preferably, the retainer 76 is a wire, cable or flat ring fabricated of steel, stainless steel or other material, however other types and quantities of retainers 76 can also be utilized such as multiple wires and springs. The retainer 76 is housed in the raceway 114 to secure the disc 72 to the hub 74.

The assembly of the floating brake rotor assembly 70 is similar to that of floating brake rotor assembly 10 in that the retainer 76 is fed through the raceway 114 to secure the disc 12 to the hub 14. In operation, the assembly 70 enables the disc 72 to be secured to the hub 74 while allowing the disc 72 to expand as needed radially or radially/axially so that torsional braking forces pass directly from the disc 72 to the hub 74. The disc 72 is secured to the hub 74 using the retainer 76 such that the torque load is passed directly between the disc 72 and hub 74 and not through any retention part securing the disc 72 to the hub 74.

The assembly 70 enables a floating disc functionality with only three parts, the disc 72, the hub 74 and the retainer 76. The weight of the assembly 70 is reduced as compared to the use of heavier retention components not being necessary for functionality.

As noted above, the invention is applicable to both full floating and semi-floating brake rotor assemblies. Specifically, the invention can be used for both full floating and semi-floating configurations by adjustment of the tightness of the fit of the retainer 16 in the raceway 62 or 114 by adjusting the width of the grooves 30/58 or 90/110 and the width of the retainer 16.

Various features and advantages of the invention are set forth in the following claims.

What is claimed is:

1. A floating brake rotor assembly comprising:
a hub having an axle axis and a plurality of spokes, each spoke having therein a groove;
a disc having a center aperture where the hub is positioned, the disc having a plurality of tabs around a periphery of the center aperture, each tab having therein a groove and each tab aligned with one spoke such that the groove on each tab is aligned with a groove on each spoke; and
a retainer positioned in each aligned groove on the hub and each groove on the disc to secure the disc to the hub and to enable the disc to move radially relative to the axle axis.

2. The floating brake rotor assembly of claim 1 wherein the retainer includes a wire.

3. The floating brake rotor assembly of claim 1 wherein the retainer is a single wire.

4. The floating brake rotor assembly of claim 1 wherein the plurality of spokes is at least three spokes.

5. The floating brake rotor assembly of claim 1 wherein each spoke includes a pair of arms and wherein each arm includes the groove of the hub.

6. The floating brake rotor assembly of claim 1 wherein each tab includes a pair of projections and the groove in each tab is positioned between the projections.

7. The floating brake rotor assembly of claim 1 wherein each spoke includes a pair of arms defining a pocket therebetween and wherein one tab is positioned in each pocket.

8. A floating brake rotor assembly comprising:
a disc having a center aperture;
a hub positioned in the center aperture and having an axle axis;
a plurality of tabs on one of the disc and the hub and a plurality of pockets on the other of the disc and the hub, wherein one tab is positioned in each pocket;
a raceway defined by a path through each of the plurality of tabs and each of the plurality of pockets; and
at least one retainer running along the raceway to secure the disc to the hub and to enable the disc to move radially relative to the axle axis.

9. The floating brake rotor assembly of claim 8 wherein the at least one retainer is a single wire.

10. The floating brake rotor assembly of claim 8 wherein the at least one retainer includes a wire.

11. The floating brake rotor assembly of claim 8 wherein the disc includes the plurality of tabs and the hub includes the plurality of pockets.

12. The floating brake rotor assembly of claim 8 wherein the pocket is positioned between two arms.

13. A floating brake rotor assembly comprising:
a disc having a center aperture and having a first surface plane and a second surface plane;
a hub positioned in the center aperture and having an axle axis and retaining portions that engage with the disc; and
a retainer securing the disc to the retaining portions of the hub to enable the disc to move radially relative to the axle axis such that the retainer and retaining portions are positioned between the first surface plane and the second surface plane.

14. The floating brake rotor assembly of claim 13 wherein the retainer includes a wire.

15. The floating brake rotor assembly of claim 13 wherein the disc and the hub have a plurality of grooves and wherein the retainer is positioned in a raceway defined by a path of the plurality of grooves.

16. The floating brake rotor assembly of claim 15 wherein the grooves of the disc are aligned with the grooves on the hub.

17. The floating brake rotor assembly of claim 15 wherein the retaining portions include spokes that include the grooves on the hub.

18. The floating brake rotor assembly of claim 15 wherein the disc has a plurality of tabs including the grooves.

19. The floating brake rotor assembly of claim 13 wherein the hub includes a plurality of pockets, wherein the disc includes a plurality of tabs, wherein one tab is positioned in each pocket, and wherein the raceway runs through each tabs and each pocket.

20. The floating brake rotor assembly of claim 13 wherein the retaining portions are positioned to be centered between the first surface plane and the second surface plane.
